(19) United States
(12) Patent Application Publication
(10) Pub. No.: US 2018/0160614 A1
(43) Pub. Date: Jun. 14, 2018

(54) STRIP TILLAGE IMPLEMENT AND METHOD

(71) Applicant: CNH Industrial America LLC, New Holland, PA (US)

(72) Inventor: Dean A. Knobloch, Tucson, AZ (US)

(73) Assignee: CNH Industrial America LLC, New Holland, PA (US)

(21) Appl. No.: 15/373,570

(22) Filed: Dec. 9, 2016

(51) Int. Cl. A01C 7/00; A01B 35/16; A01B 49/06

(52) U.S. Cl. CPC A01C 7/006; A01B 49/06; A01B 35/16

(57) ABSTRACT

A strip tillage implement includes a frame, a plurality of row units and a plurality of auxiliary tillage units. The plurality of row units are carried by the frame and spaced apart from each other at a common row spacing, with each row unit being configured for preparing a strip of soil for application of a crop input. The plurality of auxiliary tillage units are located between the row units and spaced apart from each other at the common row spacing, with each auxiliary tillage unit being configured for at least partially processing remains from an already harvested row of crop material.

### BACKGROUND OF THE INVENTION

### 1. Field of the Invention

The present invention relates to agricultural tillage implements and systems, and, more particularly, to strip tillage implements, systems and techniques.

### 2. Description of the Related Art

Conservation tillage is any method of soil cultivation that leaves the previous year's crop residue (such as corn stalks or wheat stubble) on fields before and after planting the next crop, to reduce soil erosion and runoff. Conservation tillage methods are generally thought to leave at least 30% of the soil surface which is covered with crop residue after planting the next crop. Conservation tillage methods include no till, strip till, ridge till and mulch till.

Strip-till (AKA strip tillage) uses equipment and techniques which tills the soil only in narrow strips with the rest of the field left untilled. In some cases, the entire strip till farming operation is performed in a single pass while in other cases the strip till farming operation is performed in two passes. In the single pass strip till operation, the strips are tilled, cleared of trash or crop residue, fertilized and planted, usually in the spring. In the two pass strip till operation, the strips are normally tilled and fertilized in the fall and then planted in the spring.

Most grain crops in the midwest region of the U.S. are rotated for purposes of productivity and disease resistance. For example, grain crops can be rotated every other year in certain regions with a 2 crop rotation between corn and soybeans, while in other regions a 3 crop rotation is used with corn, soybeans and wheat. Due to certain economic or other factors (e.g., ethanol production, etc.), it may be desirable to plant corn continuously, year after year.

In corn after corn strip tillage, a farmer will create the strips ½ the distance from the old corn row (e.g., with 30 inch rows, a new strip will be 15 inches from the prior corn row). Thus, with the third year of corn after corn strip tillage, the strip being created will essentially be in the same location as the old corn row of two years prior. The old corn rows consist of a corn stalk and a root ball that decays slower than the other corn residue that has been cut or crushed by harvesting equipment. This root ball causes problems with making the new strip because it will come out in large chunks creating a hole in the berm (i.e., tilled strip). The berm needs to be as uniform as possible and not have large holes or root crowns interspersed in the row.

What is needed in the art is a strip tillage implement and method that allows strip tillage and seeding in crops with larger root balls or other tougher crop material remaining below the ground surface level.

### SUMMARY OF THE INVENTION

The present invention provides a strip tillage implement with auxiliary tillage units interposed between row units for at least partially processing remains from already harvested rows of crop material.

The invention in one form is directed to a strip tillage implement including a frame, a plurality of row units and a plurality of auxiliary tillage units. The plurality of row units are carried by the frame and spaced apart from each other at a common row spacing, with each row unit being configured for preparing a strip of soil for application of a crop input. The plurality of auxiliary tillage units are located between the row units and spaced apart from each other at the common row spacing, with each auxiliary tillage unit being configured for at least partially processing remains from an already harvested row of crop material.

The invention in another form is directed to a method of strip tillage, including the steps of:

preparing a plurality of strips of soil for application of a crop input using a plurality of row units spaced apart from each other at a common row spacing; and

at least partially processing remains from an already harvested row of crop material using a plurality of auxiliary tillage units located between the row units and spaced apart from each other at the common row spacing.

The processing step can include at least partially processing below ground surface remains from the already harvested row of crop material.

An advantage of the present invention is that the additional processing of the old corn row allows it to decay so that when a strip is created the next year, the old corn row remains do not negatively affect the building of the strip.

Another advantage is that the old corn row decays and is converted into organic matter and nutrients for the next year's corn crop.

Yet another advantage is that the additional processing of the old corn row reduces the number of passes that are required in strip tillage when additional passes are needed to act on the old corn rows.

A still further advantage is that energy and labor savings result because of fewer passes through the field.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a top view of a portion of a strip tillage implement, including an embodiment of an auxiliary tillage arrangement of the present invention;

FIG. 2 is a side schematic view of an auxiliary tillage unit used in the auxiliary tillage arrangement shown in FIG. 1;

FIG. 3 is a top view of a portion of a strip tillage implement, including another embodiment of an auxiliary tillage arrangement of the present invention;

FIG. 4 is a front schematic view of another embodiment of an auxiliary tillage unit which can be used with a strip tillage implement;

FIG. 5 is a top view of a portion of a strip tillage implement, including another embodiment of an auxiliary tillage arrangement of the present invention;

FIG. 6 is a top view of a portion of a strip tillage implement, including yet another embodiment of an auxiliary tillage arrangement of the present invention; and

FIG. 7 is a top schematic view of a further embodiment of an auxiliary tillage unit of the present invention.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

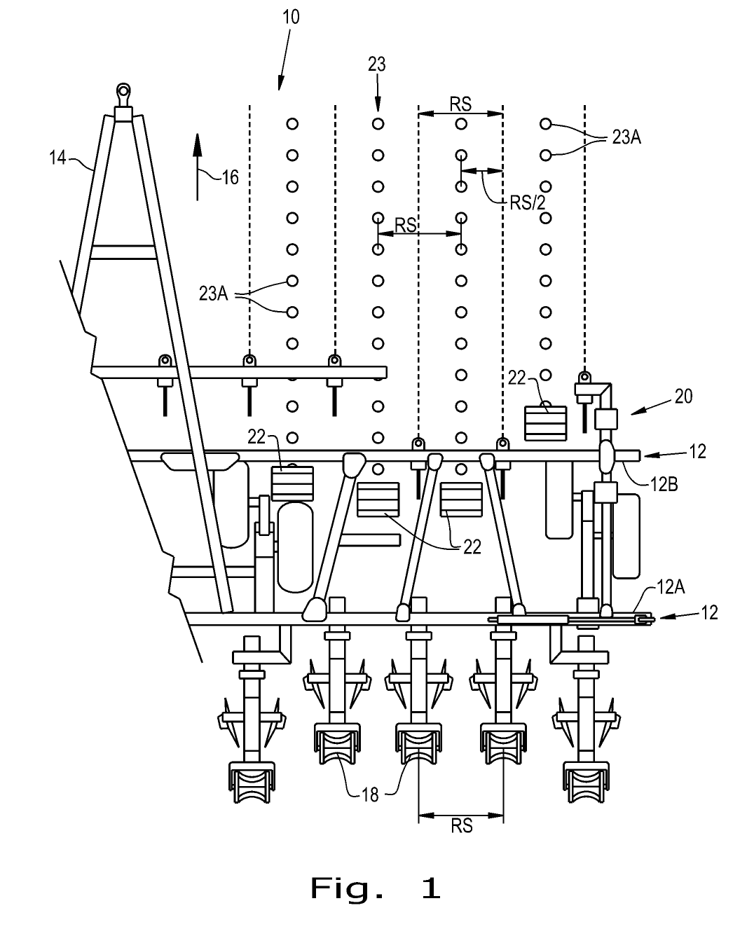

Referring now to the drawings, and more particularly to FIG. 1, there is shown a strip tillage implement 10 which generally includes a frame 12 with a hitch 14 which can be towed in a travel direction 16 by a traction unit (such as a tractor, not shown).

A plurality of row units 18 are carried by the frame 12 and spaced apart from each other at a common row spacing. In the embodiment shown, the strip tillage implement is assumed to be set up for a 30 inch row spacing (referenced RS). Each row unit 18 is configured for preparing a strip of soil for application of a crop input, such as seed, fertilizer, herbicide and/or insecticide. Examples of row units which are effective for use with a strip tillage implement are shown and described in U.S. Pat. No. 8,794,345 (Knobloch et al.), U.S. Pat. No. 7,156,186 (Knobloch et al.) and U.S. Pat. No. 6,871,709 (Knobloch et al.), each of which are assigned to the assignee of the present invention.

The frame 12 also carries an auxiliary tillage arrangement 20 with a plurality of auxiliary tillage units 22 which are located between the row units 18 and spaced apart from each other at the common row spacing RS; the same as the row spacing between the row units 18. Each auxiliary tillage unit 22 is located approximately centered between an adjacent pair of row units 18. In the embodiment illustrated in FIG. 1, the frame 12 can include a first cross frame member 12A and a second cross frame member 12B, spaced apart from each other in the travel direction 16 of the strip tillage implement 10, with the first cross frame member 12A carrying the plurality of row units 18 and the second cross frame member 12B carrying the plurality of auxiliary row units 22.

Each auxiliary tillage unit 22 is configured for at least partially processing the remains from an already harvested row of crop material 23, such as corn stalks 23A having root balls 23B below the ground surface G. The auxiliary tillage unit 22 processes the remains of the already harvested row of crop material in such a way that it will better decompose in the time period before the next crop is planted. For example, each auxiliary tillage unit 22 can be configured for at least partially processing the below ground surface remains from the already harvested row of crop material. In the case of a crop such as corn having a root ball below the ground surface, this auxiliary processing reduces the size of the root ball, returns nutrients to the soil, and allows a better strip to be formed during the following strip tillage operation.

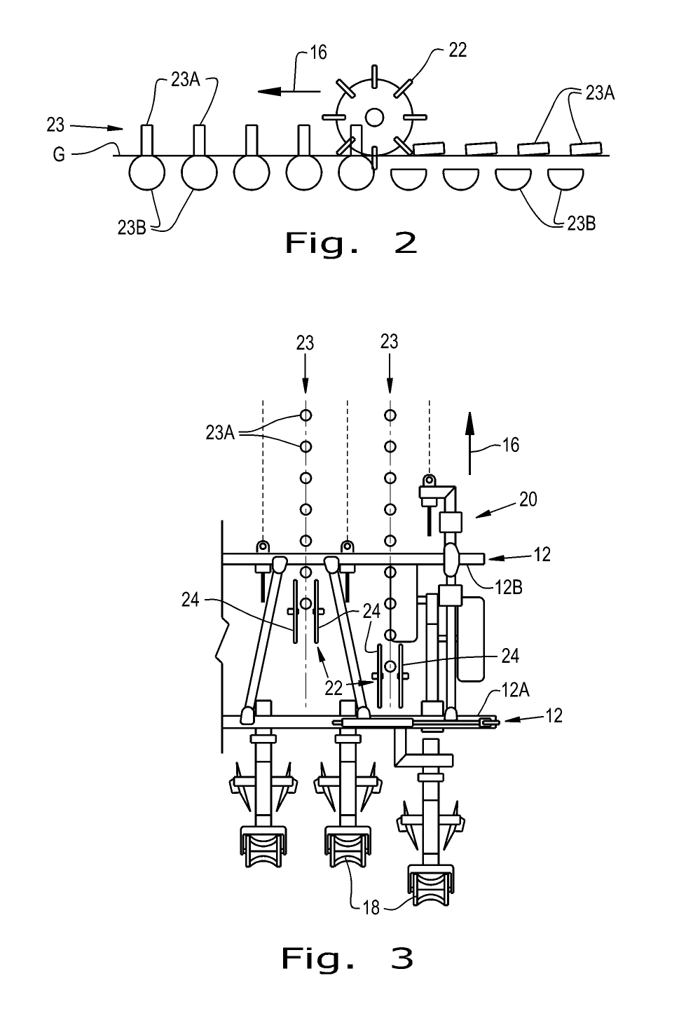

Various types of auxiliary tillage units 22 can be used with the auxiliary tillage arrangement of the present invention. For example, each auxiliary tillage unit 22 can be configured to include: at least one colter blade; at least one turbo blade; a chopper/roller device; and/or a cutting blade. In the embodiment shown in FIGS. 1 and 2, the auxiliary tillage units 22 are configured as chopper reels to chop up the corn stalks above the ground surface level and also chop up and stir the soil and upper portion of the corn root balls.

In the embodiment shown in FIG. 3, the auxiliary tillage units 22 (only 1 of which is shown) are configured as generally vertical colter blades 24 which are positioned on either side of the corn stalks and cut into each side of the root crown of the root ball. The colter blades 24 can be flat or waffled, and dislodge the root crown. The colter blades 24 can extend downwardly enough to cut through the root crown and into the root ball. An optional generally vertical third colter blade (not shown) can also be added between the colter blades 24 to dissect the corn stalks and root crown. In this embodiment, one of the auxiliary tillage units 22 is carried by first cross frame member 12A and another one of the auxiliary tillage units 22 is carried by the second cross frame member 12B. Although the various embodiment only show a few of the auxiliary tillage units, it is to be understood that auxiliary tillage units are likely positioned between each of the row units 18.

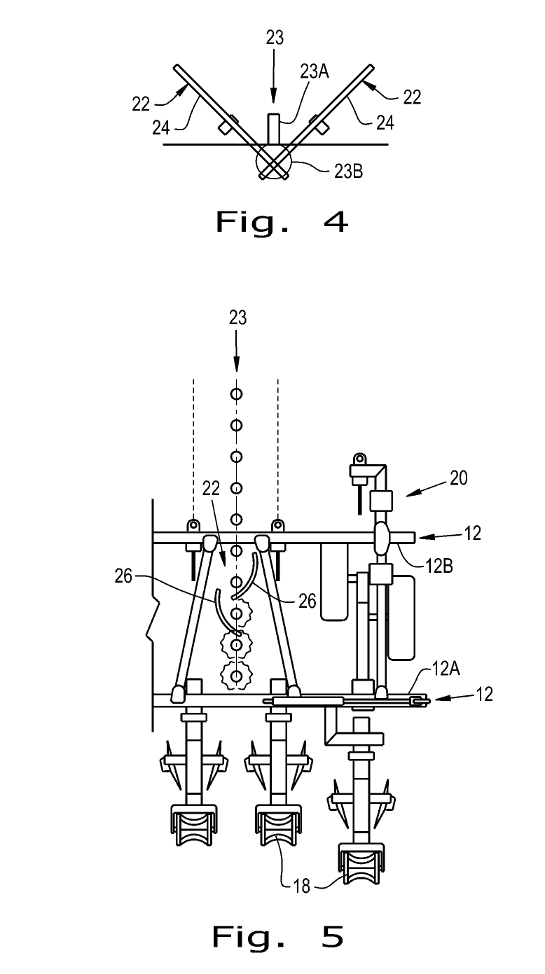

Referring to FIG. 4, another embodiment of an auxiliary tillage unit 22 can include colter blades that are oriented at an angle to cut into the underground remains of the crop. For example, the colter blades 24 can be oriented at an approximate 45° angle to dissect the root ball. The colter blades can be flat, concave or waffled.

Referring to FIG. 5, another embodiment of an auxiliary tillage unit 22 can include turbo blades 26 that cut into the underground crop remains. A first turbo blade 26 dislodges the underground crop remains in a first lateral direction, and a second turbo blade 26 dislodges the underground crop remains in an opposite second lateral direction. A Turbo Blade™ is the name of a colter blade manufactured and sold by the assignee of the present invention which uses shallow blade concavity and turbo vanes to move soil up, over and out.

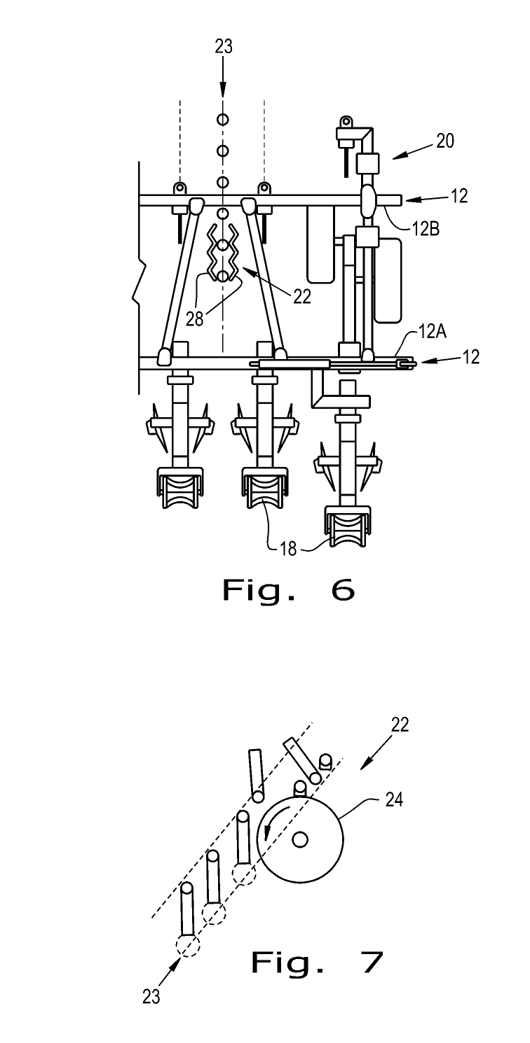

Referring now to FIG. 6, another embodiment of an auxiliary tillage unit 22 can include wavy colters 28 that cut into the underground crop remains. The wavy, waffled or fluted colters 28 can be oriented generally vertically on either side of the corn stalks, and can be spaced apart at a predetermined distance (e.g., 4 inches).

Referring now to FIG. 7, there is shown another embodiment of an auxiliary tillage unit 22 including a generally horizontal colter blade 24 acting as a cutting blade to cut off corn stalks within approximately an inch or less above the ground surface.

During operation of a strip tillage implement utilizing an auxiliary tillage arrangement 20 of the present invention, a plurality of strips of soil are prepared for application of a crop input using a plurality of row units 18 spaced apart from each other at a common row spacing RS. Remains from an already harvested row of crop material are at least partially processed using a plurality of auxiliary tillage units 22 located between the row units 18 and spaced apart from each other at the common row spacing RS. The plurality of auxiliary tillage units 22 can be used to at least partially process the below ground surface remains from the already harvested row of crop material.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A strip tillage implement, comprising:
a frame;
a plurality of row units carried by the frame and spaced apart from each other at a common row spacing, each said row unit being configured for preparing a strip of soil for application of a crop input; and
a plurality of auxiliary tillage units located between the row units and spaced apart from each other at the common row spacing, each said auxiliary tillage unit being configured for at least partially processing remains from an already harvested row of crop material.

2. The strip tillage implement of claim 1, wherein each said auxiliary tillage unit is located approximately centered between an adjacent pair of row units.

3. The strip tillage implement of claim 1, wherein each said auxiliary tillage unit is configured to include at least one of:
at least one colter blade;
at least one turbo blade;
a chopper/roller device; and
a cutting blade.

4. The strip tillage implement of claim 3, wherein each said auxiliary tillage unit is configured for at least partially processing below ground surface remains from the already harvested row of crop material.

5. The strip tillage implement of claim 3, wherein each said colter blade is flat or waffled.

6. The strip tillage implement of claim 5, wherein each said colter blade is a concave disc.

7. The strip tillage implement of claim 3, wherein the already harvested row of crop material is corn, and wherein each said cutting blade is a generally horizontal cutting blade configured to cut off corn stalks within approximately an inch or less above the ground surface.

8. The strip tillage implement of claim 1, wherein the frame includes a first cross frame member and a second cross frame member, spaced apart from each other in a travel direction of the strip tillage implement, the first cross frame member carrying the plurality of row units and the second cross frame member carrying the plurality of auxiliary row units.

9. The strip tillage implement of claim 1, wherein the crop input includes at least one of seed, fertilizer, herbicide and insecticide.

10. A method of strip tillage, comprising the steps of:
preparing a plurality of strips of soil for application of a crop input using a plurality of row units spaced apart from each other at a common row spacing; and
at least partially processing remains from an already harvested row of crop material using a plurality of auxiliary tillage units located between the row units and spaced apart from each other at the common row spacing.

11. The method of strip tillage of claim 10, wherein the at least partially processing step includes at least partially processing below ground surface remains from the already harvested row of crop material.

12. The method of strip tillage of claim 10, wherein each said auxiliary tillage unit is located approximately centered between an adjacent pair of row units.

13. The method of strip tillage of claim 10, wherein each said auxiliary tillage unit is configured to include at least one of:
at least one colter blade;
at least one turbo blade;
a chopper/roller device; and
a cutting blade.

14. The method of strip tillage of claim 13, wherein each said colter blade is flat or waffled.

15. The method of strip tillage of claim 14, wherein each said colter blade is a concave disc.

16. The method of strip tillage of claim 13, wherein the already harvested row of crop material is corn, and wherein each said cutting blade is a generally horizontal cutting blade configured to cut off corn stalks within approximately an inch or less above the ground surface.

17. The method of strip tillage of claim 10, wherein the crop input includes at least one of seed, fertilizer, herbicide and insecticide.
